(19) United States
(12) Patent Application Publication
(10) Pub. No.: US 2022/0364768 A1
(43) Pub. Date: Nov. 17, 2022

(54) AGRICULTURAL SOLAR POWER GENERATION AND CROP PRODUCTION PREDICTION MODELING SYSTEM

(71) Applicant: ENVELOPS CO., LTD., Seoul (KR)

(72) Inventors: Sung YOON, Seoul (KR); Seung Yeun HAN, Seoul (KR); Young Jae JO, Seoul (KR); Jin Suk KANG, Daegu (KR); Mi Suk LEE, Seoul (KR); Jin Moo LEE, Hanam-si (KR)

(21) Appl. No.: 17/742,295

(22) Filed: May 11, 2022

(30) Foreign Application Priority Data
May 11, 2021 (KR) 10-2021-0060637
Jul. 30, 2021 (KR) 10-2021-0100325

(51) Int. Cl. F24S 50/20; A01G 7/04

(52) U.S. Cl. CPC F24S 50/20; A01G 7/04; F24S 2201/00

(57) ABSTRACT

The present disclosure provides an agrivoltaic forecasting modeling system that can assess solar power yields and crop yield produced by an agrivoltaic system. The system may include a weather information providing component providing weather information; an agrivoltaic facility comprising a cultivation area for a crop and a structure with a solar panel and being adjacent to the crop and being operated based on setting conditions and the weather information; a power generation calculation component calculating the amount of power generation of the agrivoltaic power generation facility based on the weather information; a crop yield information calculation component calculating yield information of the crop based on the weather information and the setting conditions; and an optimal condition selection component calculating the optimal conditions for agrivoltaic system's solar power yields and crop yields based on the yield information, and therefore the crops can experience the various irradiance changes caused by the solar panel.

### PRIORITY CLAIM

This application claims the priority of Korean Patent Application No. 10-2021-0060637 filed on May 11, 2021 and Korean Patent Application No. 10-2021-0100325 filed on Jul. 30, 2021, in the Korean Intellectual Property Office, the disclosure of which is incorporated herein by reference.

### TECHNICAL FIELD

The present disclosure relates to an agrivoltaic forecasting modeling that can assess solar power yields and crop yields produced by an agrivoltaic system.

### INTRODUCTION

Recently, the development of new and renewable energy is being carried out through an agrivoltaic system. In an agrivoltaic system, a land may be used for both solar photovoltaic power generation and agriculture. For example, solar panels generating electricity and a crop farm may coexist on the same area of the land. An effective method is required for solar system design and selection of cultivated crops based on integrated forecasting modeling of electricity production and crop production. Through this method, it is necessary to derive a structural design that is more effective for power generation and crop production when a solar power facility is designed for the upper part of a cultivation area where agricultural activities are currently being carried out or where they may be performed.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

According to an aspect of the present disclosure, the forecasting agrivoltaic forecasting modeling system for solar power generation and crop production may comprise: a weather information providing component for providing weather information; an agrivoltaic power generation facility comprising a crop to be grown and a structure installed adjacent to the crop that is being operated based on setting conditions and weather conditions; a power generation calculation component for calculating power generation information of the agrivoltaic power generation facility based on the weather information; a crop yield information calculation component for calculating yield information of the crop based on the weather information and the setting conditions; and an optimal condition selection component for deriving the optimal conditions for agrivoltaic power generation based on the power generation amount and the crop yield information, the structure may include a solar panel, the solar panel may be positioned above the crop, such that the structure may be configured for the crop to be exposed to irradiation changes due to the solar panel.

Furthermore, the power generation calculation component may comprise a specification module for calculating a first amount of power generation of the agrivoltaic power generation facility based on the weather information and the first setting condition, when the agrivoltaic power generation facility is set to a first setting condition that is one of the setting conditions; and a geometry module for calculating a second amount of power generation of the agrivoltaic power generation facility based on the weather information and the second setting condition, when the agrivoltaic power generation facility is set to a second setting condition that is another of the setting conditions; the first setting condition may include a type of the agrivoltaic power generation facility including module, inverter types of the agrivoltaic power generation facility, and the second setting condition may include a height of structures constituting the agrivoltaic power generation facility, a pitch distance between the structures, and an orientation and angle of structures constituting the agrivoltaic power generation facility.

Furthermore, the power generation calculation component may generate an optimal power generation amount based on the first generation amount and the second generation amount and calculate forecasting generation amount information based on the optimal power generation amount, and the power generation calculation component may further comprise a power generation forecasting component for providing the forecasting generation amount information to the optimal condition selection component.

Furthermore, the weather information providing component may provide the weather information to the crop yield information calculation component that calculates the crop yield on at least a daily basis and provide the weather information to the agrivoltaic power generation that calculates the power yield facility every minute or every 10 minutes or every 15 minutes or every hour.

Furthermore, the geometry module may obtain a first irradiation amount value including a first irradiation amount irradiated to the crop located under the solar panel in response to the second setting condition, the yield information calculation component may comprise an irradiation change determining component for forecasting or obtaining a second irradiation amount value about the second irradiation amount irradiated to the crop based on a sensor point that is an arbitrary area designated to include the cropping area under the solar panel, the irradiation change determining component may use the first irradiation amount value or obtain the second irradiation amount value separately from the first irradiation amount value, and each of the first irradiation amount value and the second irradiation amount value may include the distribution value of irradiation according to the change of the shadow cast on the crop by the solar panel over time.

Furthermore, the sensor points may be designated as a plurality, and the second irradiation amount value may be forecasted or obtained for each sensor point.

Furthermore, the crop yield information calculation component obtains the second irradiation amount value and may further comprise the second irradiation amount value for substituting the irradiation of the weather information with the second irradiation mount value.

Furthermore, the forecasting modeling system may further comprise a first variable information providing component for providing a first variable information, the crop yield information calculation component may further comprise: a crop growth information calculation component for calculating growth information on the growth of the crop based on the substituted second irradiation and modeling for the first variable information; and a yield forecasting component calculating crop yield forecasting information based on the growth information and providing the crop yield forecasting information to the optimal condition selection component, and the first variable information may include information on at least one of germination condition information on the crop (e.g., temperature characteristics at which crops germinate, etc.), dry weight information on the crop, weight information of fruit or storage organ of the crop, light use efficiency information (e.g., efficiency of growth rate according to light irradiation), and leaf area information (e.g., the area of leaves within the set standard range, etc.).

Furthermore, the first variable information providing component may include an information extracting component for extracting the first variable information in a way that optimizes the information through a trial and error method by estimating variables from an internal or external database that provides comparison with crop production results and a first variable information providing component 153 for obtaining the extracted first variable information and provides it to the crop growth information calculation component.

Furthermore, the optimal condition selection component may calculate an optimal candidate condition based on the power generation amount and the crop yield information, in which when the calculated optimal candidate condition meets the preset condition, it is calculated as an optimal condition, and the optimal condition includes at least one of an optimal crop candidate (e.g., comparison of crop yields versus crop yields without an agrivoltaic power generation facility or determining optimal crops under the agrivoltaic power generation facility), a crop yield value, and a sales value per unit weight of crop.

Furthermore, the forecasting modeling system may further comprise a second variable information providing component 160 for providing a second variable information based on or separate from the first variable information, and the crop growth information calculation component may calculate growth information about the physiology of the crop based on the second irradiation amount value, the first variable information, and the second variable information.

Furthermore, the crop growth information calculation component may provide crop height information about the crop height and etc. to the irradiation change determining component, and the irradiation change determining component may re-measure the irradiation change value on the sensor point based on the feedback through the height information to provide a second irradiation change value.

Furthermore, the information substituting component, the crop growth information calculation component, and the irradiation change determining component may be sequentially and repeatedly operated in a loop with a set number of times, and the loop may be operated on at least a daily basis.

Furthermore, in response to the height increase of the crop, the sensor point may be corrected to an extended area including the crop in which the height increase is made, and the irradiation change determining component may predict or obtain a second irradiation amount value about a second irradiation amount irradiated to the crop based on the sensor point corresponding to the extended area.

Furthermore, the weather information providing component may provide the weather information based on the first and second weather data, the first weather data may include global climate database information, which is a measured weather data value obtained from a weather station, and wherein the second weather data may include a satellite-based solar and meteorological data value, which is an calibrated value of weather data derived from a satellite survey, and an observation value according to weather observation by a weather station.

Furthermore, the solar panel may include a first solar panel to a third solar panel, the agrivoltaic power generation facility may further comprise a base structure located adjacent to the cultivation area in which the crop is located, a first movable panel provided on the upper portion of the base structure, including the first solar panel installed on the upper portion and being slidable from side to side, a second movable panel provided on one side of the first movable panel on the upper portion of the base structure, including the second solar panel installed on the upper portion, and being slidable from side to side, and a third movable panel provided on the other side of the first movable panel on the upper portion of the base structure, including the second solar panel installed on the upper portion, and being movable from side to side, and the pitch distance may be adjusted based on the sliding of the first movable panel to the third movable panel in the solar panel.

The forecasting modeling system for agrivoltaic power generation and crop production of the present disclosure as described above results in one or more of the following effects.

The present disclosure may provide an agrivoltaic system in which a solar power facility is installed on the upper part of an environmental site where agricultural activities are carried out or can be performed to produce electricity and produce crops simultaneously at the same site, thereby making effective use of land.

Furthermore, the present disclosure may provide an agrivoltaic system in which the change in irradiation caused by the solar power panel is efficiently utilized to create an optimal micro-environment in the lower farmland, thereby allowing selection of a solar system design and selection of the optimal crop to accompany it.

Furthermore, the present disclosure may provide an agrivoltaic system that accurately analyzes the change in irradiation reaching the bottom crops beneath the solar panel and allow for suitable crop selection, and furthermore actively utilize the shadow effect from the solar panel to have a positive effect on the production environment of bottom crops or improve crop yields in environments experiencing extreme climate change.

Furthermore, the present disclosure may provide an agrivoltaic system in which crops are scientifically selected according to each crop physiological characteristic (e.g., light saturation, etc.) in the solar system to allow for more effective forecasting of crop production results (e.g., yield).

These and other aspects of the disclosure will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is an example block diagram illustrating configurations of a forecasting modeling system for agrivoltaic power generation and crop production according to some aspects of the present disclosure.

FIGS. 2-3 are example block diagrams illustrating some of the configurations according to the forecasting modeling system of FIG. 1, according to some aspects.

FIGS. 4 to 7 are example schematic views illustrating a solar panel and crops according to the forecasting modeling system of FIG. 1, according to some aspects.

FIGS. 8 to 9 are example schematic diagrams illustrating sensor point settings according to growth of crops among the configurations according to the forecasting modeling system of FIG. 1, according to some aspects.

FIG. 10 is an example diagram illustrating some of the configurations according to the forecasting modeling system of FIG. 1, according to some aspects.

FIG. 11 is an example schematic diagram illustrating some configurations of an agrivoltaic forecasting modeling system for solar power generation and crop production according to some aspects of the present disclosure.

### DETAILED DESCRIPTION

Hereinafter, a preferred embodiment of the present disclosure is described in detail with reference to the accompanying drawings. Advantages and features of the present disclosure, and a method of achieving them is apparent with reference to the embodiments described below in detail in conjunction with the accompanying drawings. However, the present disclosure is not limited to the embodiments posted below, but it may be implemented in a variety of different forms. Only the present embodiments allow the publication of the present disclosure to be complete, and they are provided to fully inform the scope of the invention to those with ordinary knowledge in the technical field to which the present disclosure belongs. The present disclosure is only defined by the scope of the claims. Corresponding reference numerals refer to like elements throughout. Further, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution

Spatially relative terms such as “below,” “beneath,” “lower,” “above,” and “upper” can be used to easily describe a correlation between different elements or components as shown in the drawings. Spatially relative terms should be understood as terms indicating different orientations of the device during use or operation in addition to the orientation shown in the drawings. For example, if an element shown in the figures is turned over, an element described as “below” or “beneath” another element may be placed “above” the other element. Accordingly, the exemplary term “below” may include both directions below and above. The element may also be oriented in other orientations, and thus spatially relative terms may be interpreted according to orientation.

Although the terms first, second, etc. are used to describe various elements, components, and/or sections, it should be understood that these elements, components, and/or sections are not limited by these terms. These terms are only used to distinguish one element, component, or section from another element, component, or section. Therefore, it goes without saying that the first element, the first component, or the first section mentioned below may be the second element, the second component, or the second section within the spirit of the present disclosure.

The terminology used in this specification is for the purpose of describing the embodiments and is not intended to limit the present disclosure. In this specification, the singular also includes the plural unless specifically stated otherwise in the phrase. As used in this specification, “comprises” and/or “comprising” does not exclude the presence or addition of one or more other components, steps, acts and/or elements to the recited elements, steps, acts and/or elements.

Unless otherwise defined, all terms (including technical and scientific terms) used in the specification may be used with meanings that can be commonly understood by those of ordinary skill in the technical field to which the present disclosure belongs. Furthermore, terms defined in a commonly used dictionary are not to be interpreted ideally or excessively unless clearly and specifically defined.

Hereinafter, embodiments of the present disclosure are described in detail with reference to the accompanying drawings, and in the description with reference to the accompanying drawings, the same or corresponding components, regardless of reference numerals, are given the same reference numbers, and overlapping descriptions thereof are excluded.

An object of the present disclosure is to provide an agrivoltaic system in which a solar power facility is installed on an upper part of a cultivation area where agricultural activities are currently being carried out or may be performed to produce electricity and to produce crops simultaneously at the same site, thereby making effective use of the land. For example, solar panel(s) of the solar power facility may be present above the cultivation area. With the solar panel(s) above the cultivation area, the crops on the cultivation area may experience a change in irradiance on the crops when compared to a configuration without any solar panels above the cultivation area.

Another object of the present disclosure is to provide an agrivoltaic system in which a change in irradiation caused by a solar power panel is efficiently utilized to create an optimal micro-environment in a lower portion of the cultivation area (e.g., on the land of the cultivation area), thereby allowing selection of a solar system design and selection of an optimal crop to accompany it.

Still another object of the present disclosure is to provide an agrivoltaic system in which a basic technology is able to accurately analyze a decrease in an amount of irradiation reaching the crops under the solar panel and to select a suitable crop for cultivation, and furthermore, take into account and actively utilize an effect of a shadow generated by the solar panel in a manner that has a positive effect on the production environment of bottom crops and/or improve crop yields in environments experiencing extreme climate changes. As used herein, an expression “bottom crop” refers to the crop cultivated below the solar power panel(s).

Yet another object of the present disclosure is to provide an agrivoltaic system in which crops are selected according to each crop growth characteristic (light saturation, etc.) in relation to the solar system to allow for more effective forecasting of crop productions.

For example, when a number of solar panels installed in the agrivoltaic system is increased, the power generated by the solar panels may be increased. However, the increased number of solar panels may increase an amount of shadows caused by the solar panels on the cultivation area, which may adversely affect the crop growth/yield due to the increased amount of shadows on the crops. On the other hand, for example, when a number of solar panels installed in the agrivoltaic system is decreased, the decreased number of solar panels may decrease an amount of shadows caused by the solar panels on the cultivation area and thus increase an amount of irradiation (e.g., by the sunlight), which may be advantageous to the crop growth/yield. However, decreasing the number of solar panels may decrease the power generated by the solar panels. Therefore, a modeling system that determines an optimal condition for the power generation and the crop yield, by considering positions of the solar panels, the number of the solar panels, and/or the solar panels' effect (e.g., due to their shadows) on the irradiation amount on the crops/cultivation area. In some aspects, the optimal condition may be determined based on modeling that considers the power generation amount and the irradiation amount for different conditions (e.g., different positions of the solar panels and their structures).

The issues addressed by the present disclosure are not limited to the issues mentioned above, and other issues not mentioned are clearly understood by those skilled in the art from the description below.

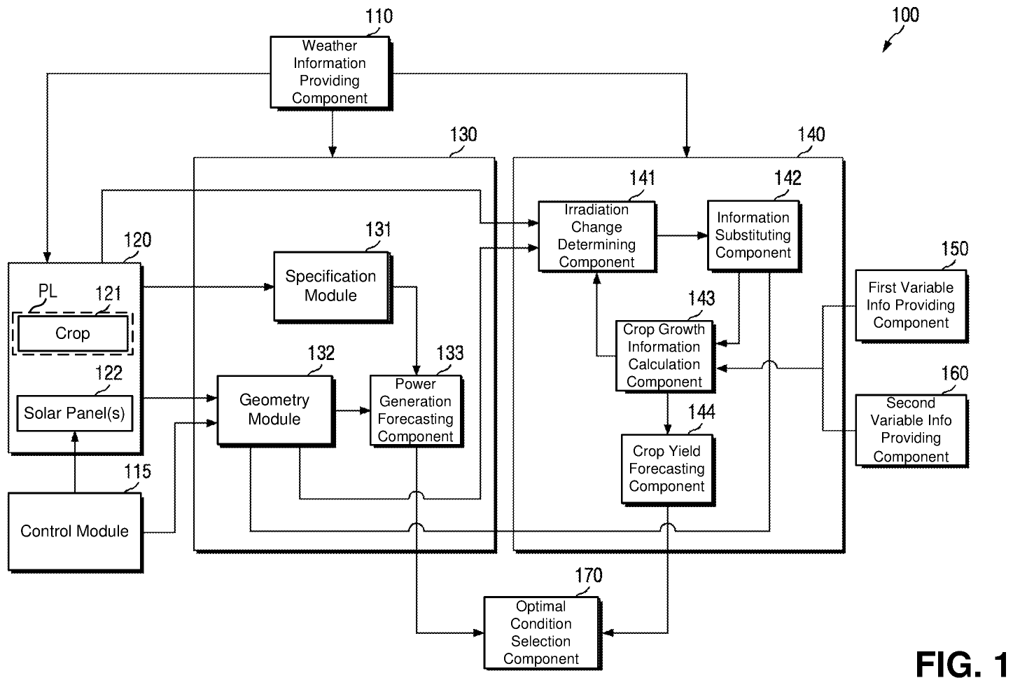

FIG. 1 is an example block diagram illustrating configurations of a forecasting modeling system 100 for agrivoltaic power generation and crop production according to some aspects of the present disclosure. In some aspects, various components and modules described in reference to FIG. 1 may be devices, such as computing devices. Referring to FIG. 1, the agrivoltaic forecasting modeling system 100 for solar power generation and crop production according to some aspects of the present disclosure comprises a weather information providing component 110 configured to provide weather information, a control module 115, an agrivoltaic power generation facility 120 configured to generate power/electricity and to grow crops, a power generation calculation component 130 configured to calculate/determine power generation information such as an amount of power/electricity generated, and a crop yield information calculation component 140 to determine information associated with crop yields. The agrivoltaic forecasting modeling system 100 of FIG. 1 may further include a first variable information providing component 150, a second variable information providing component 160, and an optimal condition selection component 170.

In some aspects, the agrivoltaic power generation facility 120 may include a solar panel 122 configured to generate electricity from sunlight. The agrivoltaic power generation facility 120 may include a cultivation area PL to grow crops 121, and thus the crops may exist within the agrivoltaic power generation facility 120. In some aspects, the agrivoltaic forecasting modeling system 100 of FIG. 1 may include a physical structure (not shown) to house one or more components of the forecasting modeling system 100. In some aspects, a structure of the agrivoltaic power generation facility 120 may include the solar panel 122. In some aspects, the solar panel 122 may include multiple solar panels 122. In some aspects, the structure of the agrivoltaic power generation facility 120 may include multiple solar panel structures to hold the multiple solar panels 122. A inter row space between two solar panel structures may be referred to as a pitch distance.

The power generation calculation component 130 may be configured to determine/calculate the power generation information of the power generated from the agrivoltaic power generation facility 120 based on the weather information and at least one of the setting conditions. In some aspects, the power generation calculation component 130 may include a specification module 131, a geometry module 132, and a power generation forecasting component 133. The crop yield information calculation component 140 may be configured to calculate yield information of the crop based on the weather information and the setting conditions. The crop yield information calculation component 140 may be configured to determine a crop yield amount, such as a crop yield amount associated with leaves, a crop yield amount associated with grains, a crop yield amount associated with crop roots, respective crop types, etc. In some aspects, the crop yield information calculation component 140 may include an irradiation change determining component 141, an information substituting component 142, a crop growth information calculation component 143, and a yield forecasting component 144.

The weather information providing component 110 may provide the weather information based on a request for providing the weather information. Here, the request for providing the weather information may be based on the power generation calculation component 130, the crop yield information calculation component 140, the agrivoltaic power generation facility 120, and the like.

The weather information providing component 110 may provide the weather information to the crop yield information calculation component 140 regularly, e.g., on at least a daily basis. The weather information providing component 110 and/or the agrivoltaic power generation facility 120 may provide the weather information periodically, e.g., every minute or every 10 minutes or every 15 minutes or every hour.

The weather information component 110 may provide the weather information based on first weather data and second weather data. The first weather data may be weather observation data obtained from a weather station. In some aspects, the first weather data may include global climate database (e.g., Meteonorm) information, which is an observed weather data value obtained from a weather station.

The second weather data may include a satellite-based solar and meteorological data value such as a National Aeronautics and Space Administration (NASA) POWER information value, which is an calibrated value of weather data derived from a satellite survey, and may further include an observation value according to weather observation obtained by a weather station. Here, the NASA POWER information may contain only daily data and daily average data of the weather, and when obtaining the observation value (e.g., first weather data), it may be difficult to collect the additional climate data necessary for crop production, such as precipitation. Therefore, it may be desirable to use both the first weather data and the second data in combination so that they can complement each other.

In some aspects, the agrivoltaic power generation facility 120 is set with a first setting condition that is one of multiple setting conditions that may be selected. The specification module 131 of the power generation calculation component 130 may calculate a first generation amount of the agrivoltaic power generation facility 120 (e.g., from the solar panel(s) 122) based on the first setting condition and the weather information. In some aspects, the first generation amount may be considered a power generation amount in general without agrivoltaic considerations (e.g., without considering the crop yields or the effect of the solar panels and their structures on the crop yields). Hence, the first generation amount may be used as a reference for a power generation amount.

In some aspects, the first setting condition may include one or more parameters related to the agrivoltaic power generation facility 120, such as a type of the agrivoltaic power generation facility 120, a module of the agrivoltaic power generation facility 120, an inverter type of the agrivoltaic power generation facility 120, and the like (e.g., corresponding to the first setting condition). Hence, for example, the first setting condition may include parameters related to how the agrivoltaic power generation facility 120 is configured and/or implemented. For example, depending the first setting condition, a different first generation amount may be calculated.

In some aspects, the agrivoltaic power generation facility 120 may be set with a second setting condition, which is another one of the multiple setting conditions. The geometry module 132 of the power generation calculation component 130 may calculate a second generation amount of the agrivoltaic power generation facility 120 (e.g., from the solar panel(s) 122) based on the second setting condition and the weather information.

In some aspects, the second setting condition may include one or more parameters, such as a height of facility structures (e.g., mounting structures mounting the solar panel(s)) constituting the agrivoltaic power generation facility 120, a pitch distance between one facility structure row and another facility structure row, an azimuth angle, inclination angle, etc. of at least some structures constituting the agrivoltaic power generation facility 120. Hence, for example, the second setting condition may be related to positions and/or dimensions of the facility structures constituting the agrivoltaic power generation facility 120. For example, depending on the second setting condition, the positions and/or dimensions of the facility structures constituting the agrivoltaic power generation facility 120 may be different, and thus the second generation amount may be different (e.g., because different positions and/or dimensions of the facility structures may cause a different number of solar panels 122). Further, for the positions and/or dimensions of the facility structures constituting the agrivoltaic power generation facility 120, the irradiation amount on the cultivation area may be different (e.g., because different positions and/or dimensions of the facility structures may cause different amount of shadows/sunlight on the cultivation area).

Hence, unlike the first generation amount, the second generation amount is determined based the parameters that are considered to balance power generation and crop yields in agrivoltaic power generation, such as the height of facility structures constituting the agrivoltaic power generation facility 120, a pitch distance between the facility structures, an azimuth angle, inclination angle, etc. of at least some structures. In some aspects, the second generation amount may not be greater than the first generation amount.

In some aspects, the setting conditions may include multiple second setting conditions, depending on the values of the parameters associated with the multiple second setting conditions. For example, one second setting condition and another second setting condition may include different heights and/or different pitch distances.

The control module 115 may control the operation of at least the solar panel 122 of the agrivoltaic power generation facility 120. In other words, the solar panel 122 may be controlled by a setting condition from the multiple setting conditions discussed above. The geometry module 132 may communicate with the control module 115 to calculate the second generation amount.

The power generation forecasting component 133 of the power generation calculation component 130 may generate an optimal power generation amount based on the first generation amount and the second generation amount. For example, as discussed above, the first generation amount may be calculated based on the first setting condition and the weather information, while the second generation amount may be calculated based on the second setting condition and the weather information. The power generation forecasting component 133 may determine/calculate power generation amount forecast information based on the optimal power generation amount.

The power generation forecasting component 133 may provide the power generation amount forecast information on the forecasted power generation amount to the optimal condition selection component 170. The optimal condition selection component 170 may be configured to determine/calculate an optimal condition for agrivoltaic power generation based on the power generation information and the crop yield information. In an example, the first generation amount and the second generation amount may be summed on at least a daily basis, and the optimal condition selection component 170 may calculate the optimal condition on an annual basis. In some aspects, the optimal condition selection component 170 may consider different second generation amounts depending on respective multiple second setting conditions, and may select one of the multiple second setting conditions as the optimal condition. In an example, the optimal condition may be different depending on whether power generation is more preferred than crop yields or whether the crop yields are more important than the power generation. Hence, in this example, if the power generation is more preferred, one second setting condition of the multiple second setting conditions may correspond to the optimal condition, while another second setting condition of the multiple second setting conditions may correspond to the optimal condition if the crop yields are more important.

Meanwhile, the geometry module 132 may obtain a first irradiation amount value including a first irradiation amount irradiated (e.g., directly and/or indirectly by the sunlight) to the crop(s) 121 of the cultivation area PL positioned below the solar panel 122 based on the second setting condition. Hence, for example, the first irradiation amount may be considered as a total irradiation amount on the entire cultivation area PL.

Based on a sensor point, which may be an arbitrary area designated to include the crop(s) 121 of the cultivation area PL below the solar panel 122, the irradiation change determining component 141 of the crop yield information calculation component 140 may predict or simulate a second irradiation amount value regarding a second irradiation amount irradiated to the crop(s) 121 of the cultivation area PL (e.g., directly and/or indirectly by the sunlight), e.g., based on the sensor point using a 3 dimensional (3D) raytracing model. Hence, for example, the second irradiation amount may be for an amount of irradiation corresponding to a portion corresponding to the sensor point, which is a portion of the area corresponding to the cultivation area PL. For example, the cultivation area PL may correspond to an area made up of multiple sensor points, and there may be multiple second irradiation amounts respectively corresponding to the multiple sensor points.

In some aspects, the second irradiation amount value related to the second irradiation amount may be directly measured using the irradiation change determining component 141 and/or may be obtained by a value measured through other measuring means.

In some aspects, the sensor point may represent a bottom crop distribution. In some aspects, the sensor point may have one sensor point area per 1 to 4 square meters, and the point may be located at a center of each sensor point area. The irradiation amount reaching the bottom crop may be used to predict an irradiation amount for each sensor point (SP) through 3D raytracing modeling, and the irradiation amount of the sensor point may be treated as an average irradiation amount value of each area.

The sensor point may be also set by the irradiation change determining component 141 or may be set through other setting means. In addition, the irradiation change determining component 141 may use the first irradiation amount value.

The first irradiation amount value and the second irradiation amount value may each include a respective distribution value of irradiation according to a change in the shadow cast on the crop(s) 121/cultivation area PL by the solar panel 122 over time.

Meanwhile, multiple sensor points may be designated, and the second irradiation amount value may be forecasted or obtained for each of the multiple sensor points. The information substituting component 142 of the crop yield information calculation component 140 may obtain the second irradiation amount value and substitutes the irradiation amount based on the weather information with the second irradiation amount.

The first variable information providing component 150 may provide first variable information, based on a request. Here, the crop growth information calculation component 143 of the crop yield information calculation component 140 may calculate growth information about the growth of the crops 121 of the cultivation area PL based on modeling for the second irradiation amount (e.g., second irradiation amount substituted for the irradiation amount based on the weather information) and the first variable information.

The yield forecasting component 144 of the crop yield information calculation component 140 may determine/calculate crop yield forecasting information based on the crop growth information. More specifically, the yield forecasting component 144 may provide the crop yield forecasting information to the optimal condition selection component 170.

Meanwhile, the first variable information may include information on at least one of germination condition information on the crop(s) 121 of the cultivation area PL (e.g., temperature characteristics at which crops 121 germinate, etc.), dry weight information on the crop(s) 121, weight information of fruit on the crop(s) 121, light use efficiency information (e.g., efficiency of a growth rate according to a light irradiation such as sunlight irradiation), or photosynthesis-related information (e.g., the area of leaves within the set standard range, etc.).

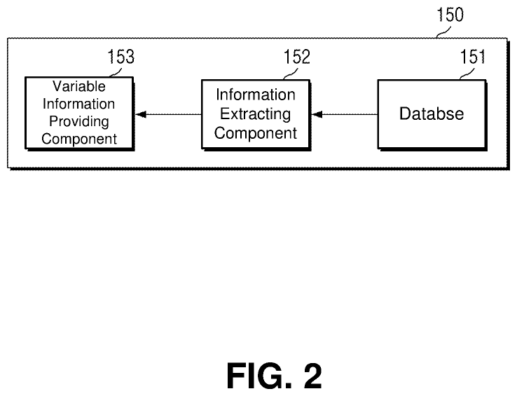

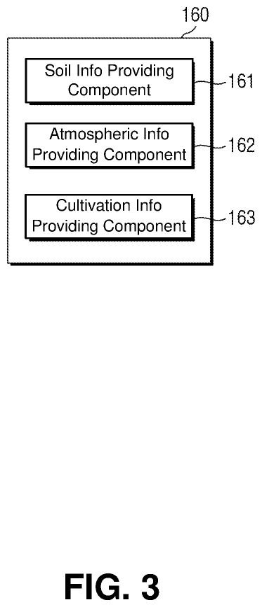

FIGS. 2-3 are example block diagrams illustrating some of the configurations according to the forecasting modeling system 100 of FIG. 1, according to some aspects. As shown in FIG. 2, in some aspects, the first variable information providing component 150 may include a database 151, an information extracting component 152, and a first variable information providing component 153. Referring to FIG. 2, the database 151 of the first variable information providing component 150 may be provided in at least one of an inside or an outside of the first variable information providing component 150. The information extracting component 152 of the first variable information providing component 150 may extract variable information (e.g., first variable information) in an optimal manner in which variables are estimated from the database 151 and compared with crop production results through the trial and error method. In an example, the database 151 may provide comparisons of different production results. In an example, the database 151 may include irradiation amount data, power generation amount data, input data for simulations, weather data, and variables associated with different types of crops.

Here, in some aspects, the first variable information providing component 153 of the first variable information providing component 150 may obtain the extracted first variable information from the information extracting component 152 and provides it to the crop growth information calculation component 143.

Furthermore, in some aspects, referring back to FIG. 1, the optimal condition selection component 170 may calculate an optimal candidate condition based on the power generation amount and the crop yield information. Here, the optimal condition selection component 170 determines that the optimal candidate condition is the optimal condition if the calculated optimal candidate condition meets a preset condition. The optimal condition includes one or more parameters, including at least one of an amount of solar power generation (e.g., by the solar panel 122) or a sale value per unit energy (e.g., per kWh) of sunlight, and at least one of optimal crop candidates, a crop yield value, or the sale value per unit weight (e.g., per kilogram) of a particular crop (e.g., from the optimal crop candidates).

In some aspects, the second variable information providing component 160 may provide the second variable information based on the first variable information or may be generated separately from the first variable information. Here, the crop growth information calculation component 143 may calculate growth information regarding the growth of the crop(s) 121 based on the second irradiation amount value, the first variable information, and the second variable information.

As shown in FIG. 3, according to some aspects, the second variable information providing component 160 may include a soil information providing component 161, an atmospheric information providing component 162, and a cultivation information providing component 163. Referring to FIG. 3, the soil information providing component 161 of the second variable information providing component 160 may provide soil information on a particular type of soil for the cultivation of the crop(s) 121. The atmospheric information providing component 162 of the second variable information providing component 160 may provide atmospheric information on atmospheric carbon dioxide concentration for the cultivation of the crop.

The cultivation information providing component 163 of the second variable information providing component 160 provides cultivation method information on a cultivation method applied to the crop(s) 121. Here, the growth information is generated by assuming that the growth information is to be generated per preset period (e.g., daily basis, etc.).

The crop growth information calculation component 143 may provide information on at least one of the height information on the height of the crop(s) 121 or the dry weight information of the crop(s) 121 to the irradiation change determining component 141.

The irradiation change determining component 141 may provide a second irradiation change value by re-measuring the irradiation change value on the sensor point based on feedback according to the height information.

The information substituting component 142, the crop growth information calculation component 143, and the irradiation change determining component 141 may be sequentially and repeatedly operated in a loop with a set number of times, and the loop may be operated on at least a least daily basis.

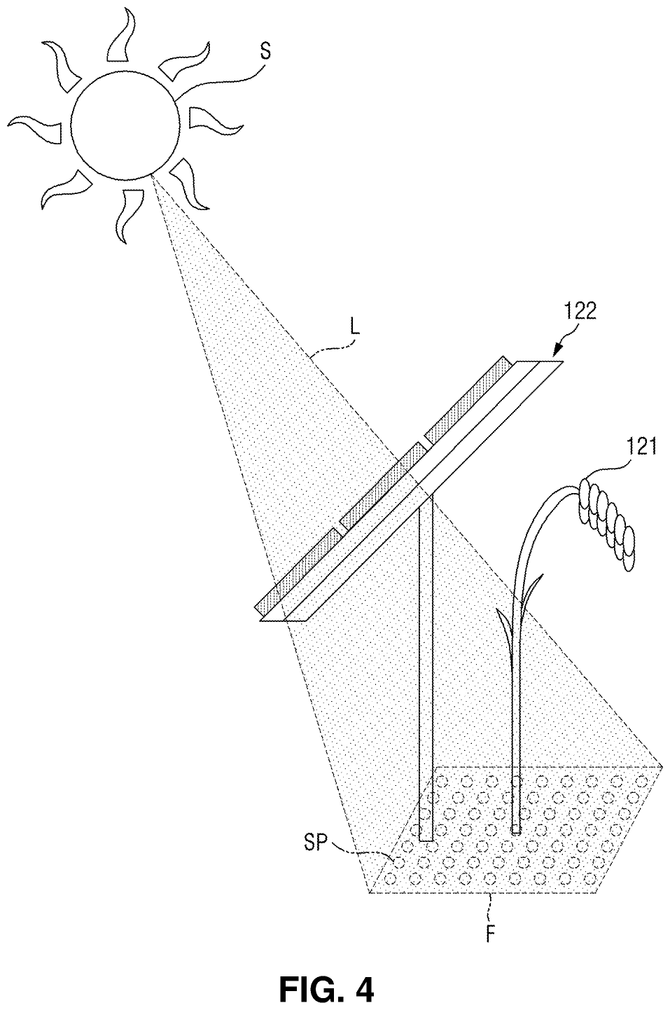

Here, the sensor point may be set in various forms. FIGS. 4-7 are example schematic views illustrating a solar panel 122 and a crop 121 according to the forecasting modeling system 100 of FIG. 1, according to some aspects. In some aspects, the solar panel 122 and the crop 121 of FIGS. 4-7 may correspond to the solar panel 122 and the crop 121 of FIG. 1. As shown in FIG. 4, each sensor point SP can be provided/set as a point on a crop field F including the crop (e.g., crop 121). In FIG. 4, the sensor points are illustrated by a corresponding grid.

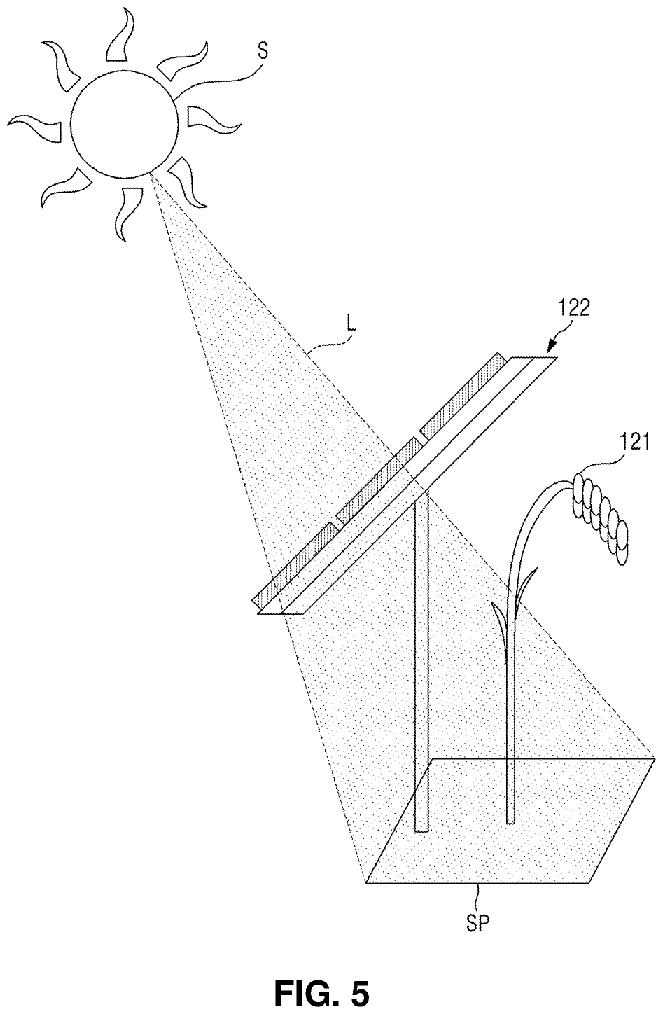

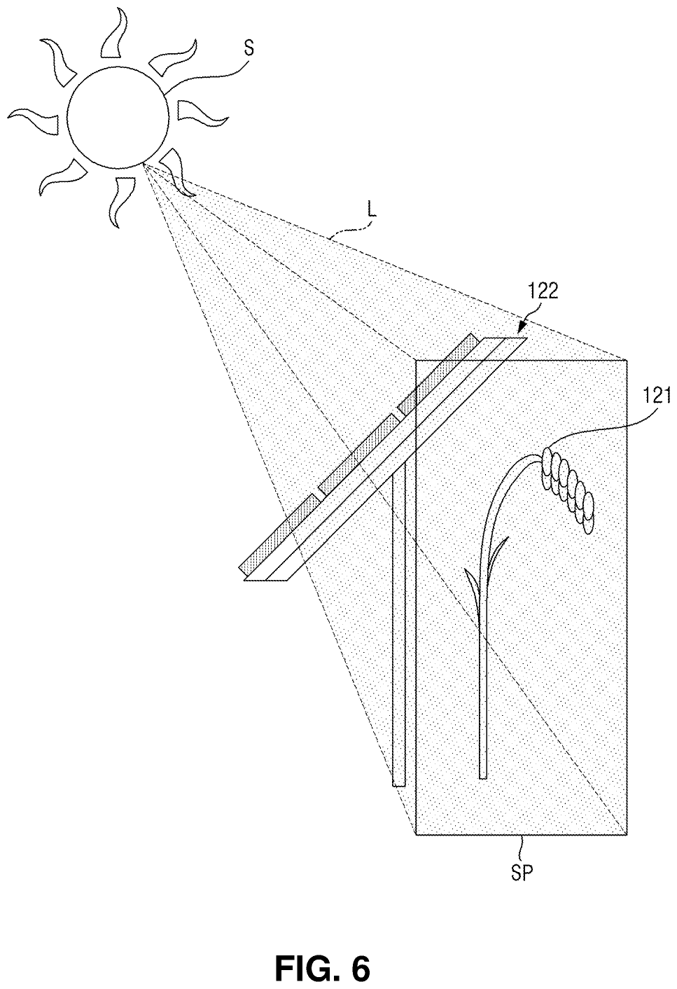

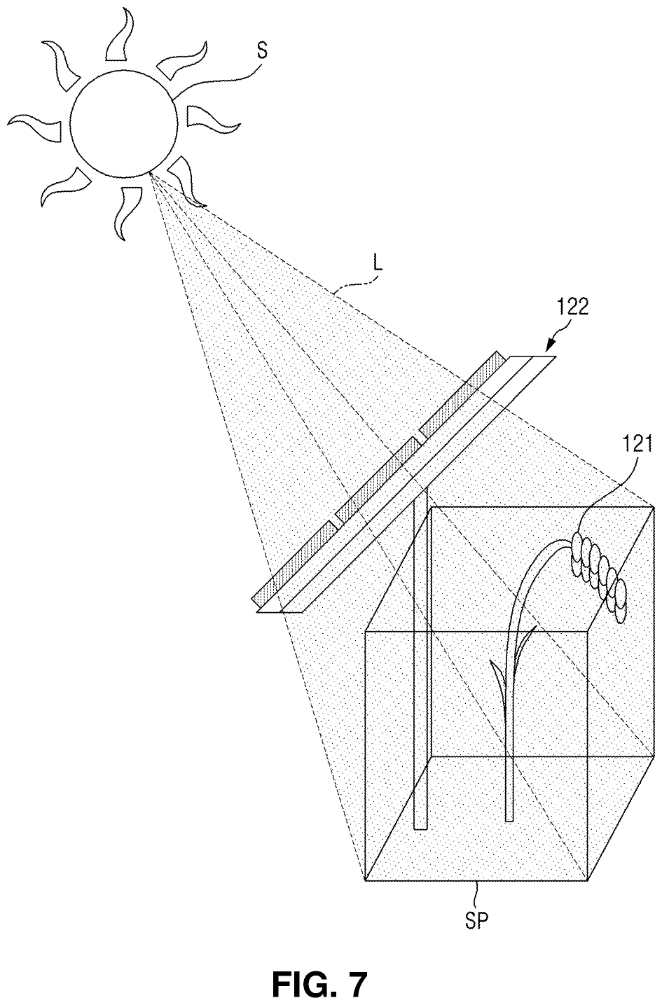

In some aspects, as shown in FIG. 5, the sensor point SP includes the crop 121 and is set as a plane in the horizontal direction. In some aspects, as shown in FIG. 6 the sensor point SP may be set as a vertical plane including the crop 121. In some aspects, as shown in FIG. 7, the sensor point SP may be set as a three-dimensional shape including the crop.

Preferably, in some aspects, the sensor point may be located at the center of the set area, and the irradiation value at the derived point is treated as an average value of the area. In some aspects, the set area may be set to a size of at least 4 square meters in order to realize the distribution of crops in maximum detail.

In some aspects, the shape of the sensor point SP may be selected so that the grid shape (e.g., the grid of FIG. 4) may reside inside the three-dimensional space (e.g., the three-dimensional shape of FIG. 7).

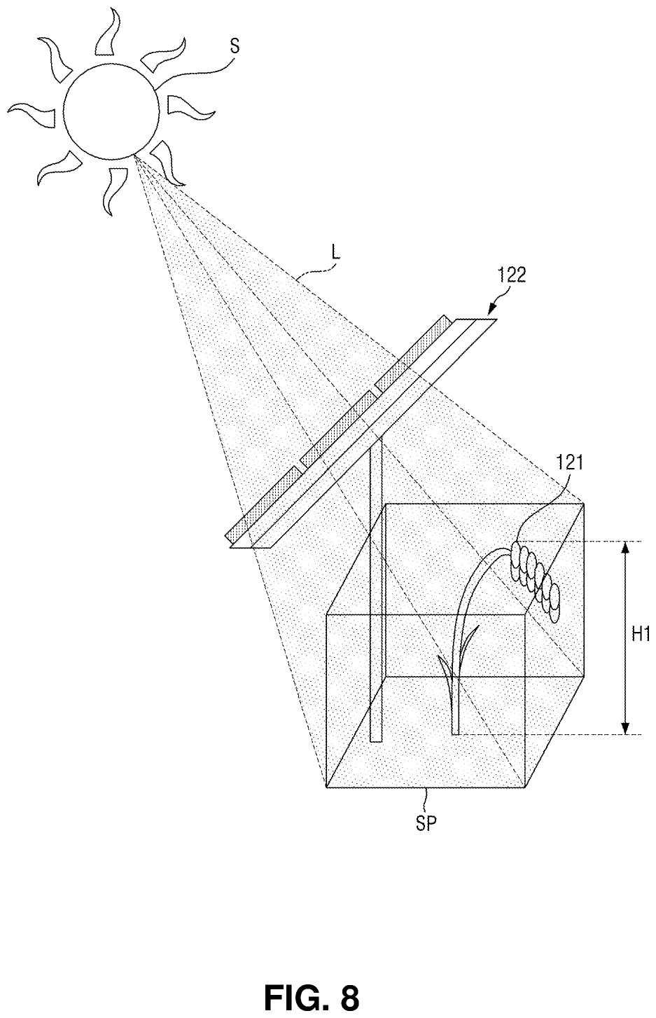

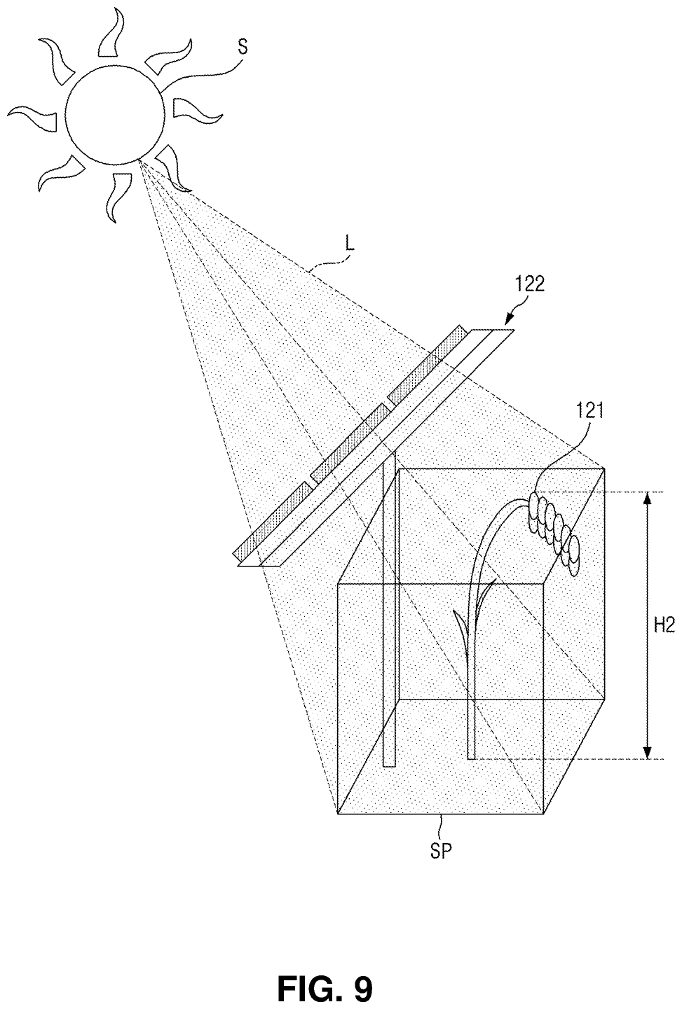

FIGS. 8-9 are example schematic diagrams illustrating sensor point settings according to growth of crops among the configurations according to the forecasting modeling system 100 of FIG. 1, according to some aspects. In some aspects, the solar panel 122 and the crop 121 of FIGS. 8-9 may correspond to the solar panel 122 and the crop 121 of FIG. 1. Referring to FIGS. 8-9, the sensor point SP may be adjusted based on a change in the height of the crop 121. When the crop grows from the first height H1 to second height H2, the sensor point SP may also correspond to the second height H2 from the first height H1 so that the sensor point SP is adjusted to include the extended area including the crop 121 based on the second height H2.

Meanwhile, in some aspects, referring back to FIG. 1, the irradiation change determining component 141 may predict or obtain a second irradiation amount value regarding the second irradiation amount irradiated to the crop(s) 121 based on the sensor point SP corresponding to the extended area based on the increased height of the crop 121. On the other hand, if the height of the crop 121 is reduced, the sensor point SP may be reduced to be adjusted based on the reduced height of the crop 121. Hence, if the height of the crop 121 is reduced, the irradiation change determining component 141 may predict or obtain a second irradiation amount value regarding the second irradiation amount based on the sensor point SP corresponding to the reduced area based on the reduced height of the crop 121.

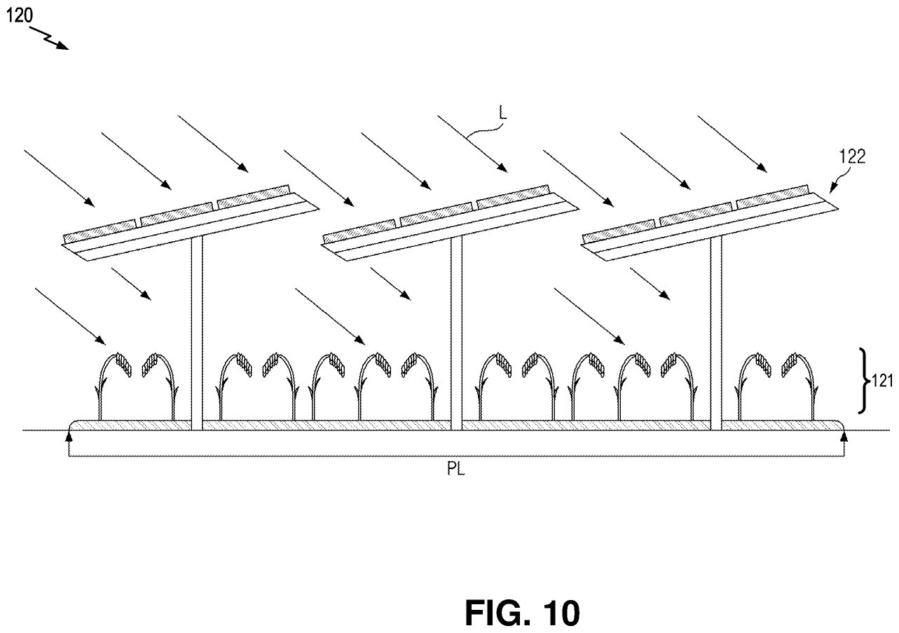

FIG. 10 is an example diagram illustrating some of the configurations according to the forecasting modeling system 100 of FIG. 1, according to some aspects. Referring to FIG. 10, in the agrivoltaic forecasting modeling system 100 for solar power generation and crop production according to an aspect of the present disclosure, the crop(s) 121 is located in a certain cultivation area PL below the solar panels 122 of the agrivoltaic power generation facility 120. The solar panel 122 is constantly positioned on the cultivation area PL, and the crop(s) 121 is affected by irradiation by the solar panels 122. In some aspects, the agrivoltaic power generation facility 120, the solar panels 122, the crop(s) 121, and the cultivation area PL of FIG. 10 may correspond to the agrivoltaic power generation facility 120, the solar panel 122, the crop(s) 121, and the cultivation area PL of FIG. 1. Further, as shown in FIG. 1, the parameters for the second setting condition such as a height of the solar panel structures, a distance between adjacent solar panel structures (a pitch distance), as well as angles of the solar panels and their solar panel structures may affect an amount of power generated by the solar panels 122 as well as an irradiation amount on the cultivation area PL that is strongly relevant to the crop yield.

Meanwhile, hereinafter, a configuration according to another embodiment of the present disclosure is mainly described with reference to a part having technical characteristics based on the above content.

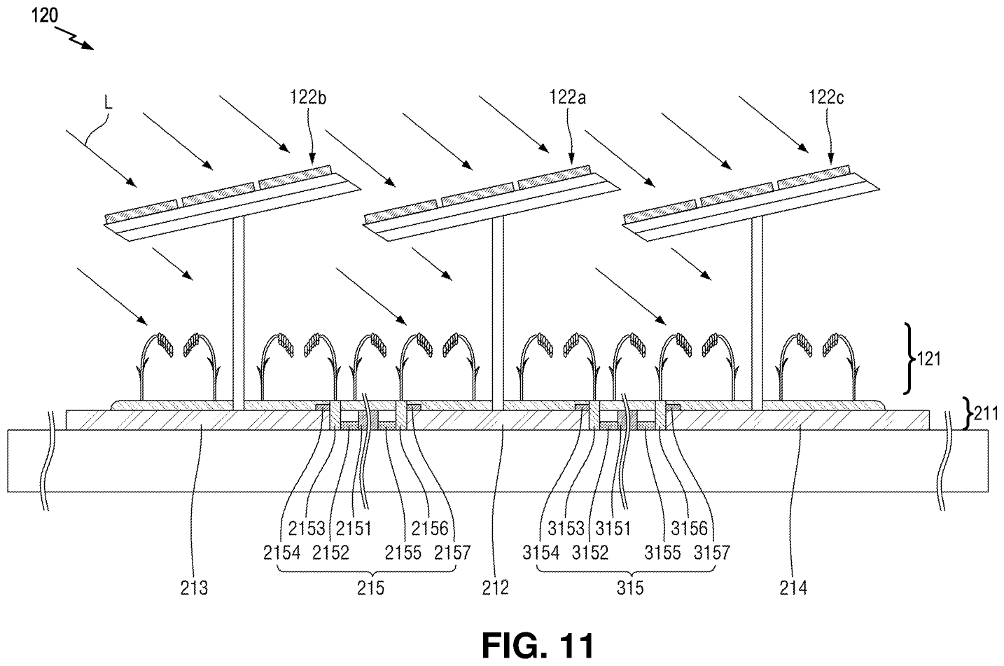

FIG. 11 is an example schematic diagram illustrating some configurations of an agrivoltaic forecasting modeling system for solar power generation and crop production according to some aspects of the present disclosure. Referring to FIG. 11, a agrivoltaic forecasting modeling system 100 for solar power generation and crop production according to another embodiment of the present disclosure comprises a solar panel 122 and a pitch management module. The solar panel 122 comprises a first solar panel 122a, a second solar panel 122b, and a third solar panel 122c. In some aspects, the agrivoltaic power generation facility 120, the solar panel 122, the crop(s) 121, and the cultivation area PL of FIG. 10 may correspond to the agrivoltaic power generation facility 120, the solar panel 122, the crop(s) 121, and the cultivation area PL of FIG. 1.

In FIG. 11, the pitch management module comprises a base structure 211, a first movable panel 212, a second movable panel 213, a third movable panel 214, a first gap control module 215, a third movable panel 214, and a second gap control module 315.

The first gap control module 215 may include a first movable structure 2151, a first connecting body 2152, a first contact body 2153, a second connecting body 2155, and a second contact body 2156. The second gap control module 315 comprises a second movable structure 3151, a third connecting body 3152, a third contact body 3153, a fourth connecting body 3155, and a fourth contact body 3156.

In some aspects, the pitch management module may adjust the pitch distance of the agrivoltaic power generation facility 120. In some aspects, the pitch management module may be provided adjacent to the cultivation area (PL) in which the crop 121 is located.

The first movable panel 212 is provided on the base structure 211. The first movable panel 212 may be provided with the first solar panel 122a installed on the upper portion, and it may be slidable side to side on the base structure 211.

Meanwhile, the second movable panel 213 is provided on one side of the first movable panel 212 above the base structure 211. The second movable panel 213 may be provided with the second solar panel 122b installed on the upper portion, and it may be slidable side to side on the base structure 211.

The third movable panel 214 is provided on the other side of the first movable panel 212 above the base structure 211. The third movable panel 214 may be provided with the third solar panel 122c installed on the upper portion, and it may be slidable side to side.

Here, the base structure 211 and the first movable panel 212, the second movable panel 213, and the third movable panel 214 are positioned as a side part of the crop in the cultivation area. In the solar panel 122, the pitch distance may be adjusted based on sliding of the first movable panel 212 to the third movable panel 214.

The first gap control module 215 of the pitch management module may be provided on the base structure 211 to be positioned between the first movable panel 212 and the second movable panel 213.

The first movable structure 2151 of the first gap control module 215 may be provided between the first movable panel 212 and the second movable panel 213 on the base structure 211.

The first contact body 2153 of the first gap control module 215 may be connected to the first movable panel 212 through a first connecting body 2152 provided on one side of the first movable structure 2151.

Furthermore, the second contact body 2156 of the first gap control module 215 may be connected to the second movable panel 213 through a second connecting body 2155 provided on the other side of the first movable structure 2151.

Both the first contact body 2153 and the second contact body 2156 may be moved forward and backward to limit the degree to which the second movable panel 213 approaches the first movable panel 212 or to reduce the approach speed.

Meanwhile, the second gap control module 315 of the pitch management module may be provided on the base structure 211 to be positioned between the first movable panel 212 and the third movable panel 214.

The second movable structure 3151 of the second gap control module 315 may be provided between the first movable panel 212 and the third movable panel 214 on the base structure 211.

The third contact body 3153 of the second gap control module 315 may be connected to the first movable panel 212 through a third connecting body 3152 provided on one side of the second movable structure 3151.

The fourth contact body 3156 of the second gap control module 315 may be connected to the third movable panel 214 through a fourth connecting body 3155 provided on the other side of the second movable structure 3151.

Here, both the third contact body 3153 and the fourth contact body 3156 may be moved forward and backward to limit the degree to which the third movable panel 214 approaches the first movable panel 212 or to reduce the approach speed.

The first movable body 2154 may be provided on the outside in the height direction of the first contact body 2153 to be movable up and down. The first movable body 2154 may press and fix the upper portion of the second movable panel 213 in an adjacent state. The second movable body 2157 may be provided on the outside in the height direction of the second contact body 2156 to be movable up and down. The second movable body 2157 may press and fix the upper portion of the first movable panel 212 in an adjacent state.

The third movable body 3154 may be provided on the outside in the height direction of the third contact body 3153 to be movable up and down. The third movable body 3154 may press and fix the upper portion of the first movable panel 212 in an adjacent state. The fourth movable body 3157 may be provided on the outside in the height direction of the fourth contact body 3156 to be movable up and down. The fourth movable body 3157 may press and fix the upper portion of the third movable panel 214 in an adjacent state.

Meanwhile, it is obvious that the technical elements of the present disclosure are implemented as components for modeling as well as actual devices and systems based on this. In other words, the present disclosure may be implemented as a agrivoltaic forecasting modeling system for solar power generation and crop production and an agrivoltaic generation system based thereon.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. An agrivoltaic forecasting modeling system for solar power generation and crop production, the system comprising:
a weather information providing component configured to provide weather information;
an agrivoltaic power generation facility comprising a cultivation area for a crop to be grown and a structure installed adjacent to the crop and being operated based on one or more setting conditions and the weather information, the structure including a solar panel;
a power generation calculation component configured to calculate power generation information of power generated from the agrivoltaic power generation facility based on the weather information and at least one of the one or more setting conditions;
a crop yield information calculation component configured to calculate yield information of the crop based on the weather information and the one or more setting conditions; and
an optimal condition selection component configured to calculate optimal conditions for agrivoltaic power generation based on the power generation information and the crop yield information,
wherein the solar panel is positioned above the crop to cause changes in irradiance on the crop.

2. The agrivoltaic forecasting modeling system of claim 1, wherein the power generation calculation component comprises:
a specification module, when the agrivoltaic power generation facility is set to a first setting condition of the one or more setting conditions, configured to calculate a first generation amount of power generation of the agrivoltaic power generation facility based on the weather information and the first setting condition; and
a geometry module, when the agrivoltaic power generation facility is set to a second setting condition of the one or more setting conditions, configured to calculate a second generation amount of power generation of the agrivoltaic power generation facility based on the weather information and the second setting condition,
wherein the first setting condition includes a type of the agrivoltaic power generation facility including module and inverter type of the agrivoltaic power generation facility,
wherein the second setting condition includes a height of facility structures constituting the agrivoltaic power generation facility, a system height, a pitch distance between the inter row of the facility structures, and an orientation and an angle of the facility structures constituting the agrivoltaic power generation facility, and
wherein the power generation information includes the first generation amount and the second generation amount.

3. The agrivoltaic forecasting modeling system of claim 2, wherein the power generation calculation component generates an optimal power generation amount based on the first generation amount and the second generation amount and calculates power generation amount forecast information based on the optimal power generation amount,
wherein the power generation calculation component further comprises a power generation forecasting component configured to provide the power generation amount forecast information to the optimal condition selection component.

4. The agrivoltaic forecasting modeling system of claim 1, wherein the weather information providing component is configured to provide the weather information to the crop yield information calculation component that calculates the crop yield periodically on at least a daily basis and to provide the weather information to the agrivoltaic power generation facility that calculates the power yield periodically.

5. The agrivoltaic forecasting modeling system of claim 2, wherein the geometry module is configured to obtain, in response to the second setting condition, a first irradiation amount value corresponding to a first irradiation amount irradiated to the crop located under the solar panel,
wherein the crop yield information calculation component comprises an irradiation change determining component configured to forecast and/or to obtain a second irradiation amount value corresponding to the second irradiation amount irradiated to the crop based on a sensor point that is an area designated to include the crop under the solar panel,
wherein the irradiation change determining component is configured to utilize the first irradiation amount value and/or to obtain the second irradiation amount value separately from the first irradiation amount value, and
wherein each of the first irradiation amount value and the second irradiation amount value includes a respective distribution value of irradiation of a change of a shadow cast on the crop by the solar panel over time.

6. The agrivoltaic forecasting modeling system of claim 5, wherein the sensor point includes a plurality of sensor points, and
wherein the second irradiation amount value is forecasted or obtained for each sensor point of the plurality of sensor points.

7. The agrivoltaic forecasting modeling system of claim 6, wherein the crop yield information calculation component obtains the the second irradiation amount value and further comprises an information substituting component configured to obtain the second irradiation amount value to substitute the weather information.

8. The agrivoltaic forecasting modeling system of claim 7, further comprising a first variable information providing component configured to provide first variable information,
wherein the crop yield information calculation component further comprises:
a crop growth information calculation component configured to calculate growth information on growth of the crop based on the second irradiation and modeling for the first variable information; and
a yield forecasting component configured to calculate crop yield forecasting information based on the crop growth information and to provide the crop yield forecasting information to the optimal condition selection component, and
wherein the first variable information includes information on at least one of a germination condition information on the crop, dry weight information on the crop, weight information of fruit on the crop, light use efficiency information, or leaf area information.

9. The agrivoltaic forecasting modeling system of claim 8, wherein the optimal condition selection component is configured to determine an optimal candidate condition based on the power generation amount and the crop yield information, wherein, when the determined optimal candidate condition meets a preset condition, the determined optimal candidate condition is set as an optimal condition, and
wherein the optimal condition includes at least one of an optimal crop candidate, a crop yield value, or a sales value per kilogram of the crop.

10. The agrivoltaic forecasting modeling system of claim 8, further comprising second variable information providing component configured to provide second variable information based on or separate from the first variable information,
wherein the crop growth information calculation component is configured to calculate the growth information about the growth of the crop based on the second irradiation amount, the first variable information, and the second variable information.

11. The agrivoltaic forecasting modeling system of claim 10, wherein the crop growth information calculation component is configured to provide at least one of height information about the crop height or dry weight information to the irradiation change determining component, and
wherein the irradiation change determining component is configured to re-measure the irradiation change value on the sensor point based on feedback according to the height information to provide a second irradiation change value.

12. The agrivoltaic forecasting modeling system of claim 11, wherein the information substituting component, the crop growth information calculation component, and the irradiation change determining component are sequentially and repeatedly operated in a loop with a set number of times, and wherein the loop is operated at least on at least daily basis.

13. The agrivoltaic forecasting modeling system of claim 12, wherein in response to a height increase of the crop, the sensor point is extended to an extended area to accommodate the crop after the height increase,
wherein the irradiation change determining component is configured to determine or obtain a second irradiation amount value about a second irradiation amount irradiated to the crop based on the sensor point corresponding to the extended area.

14. The agrivoltaic forecasting modeling system of claim 1, wherein the weather information providing component is configured to provide the weather information based on first weather data and second weather data,
wherein the first weather data includes global climate database information, which is a measured weather data value obtained from a weather station, and
wherein the second weather data includes a satellite-based solar and meteorological data value, which is an calibrated value of weather data derived from a satellite survey, and an observation value according to weather observation by a weather station.

15. The agrivoltaic forecasting modeling system of claim 2, wherein the solar panel includes a first solar panel, a second solar panel, and a third solar panel,
wherein the agrivoltaic power generation facility further comprises a pitch management module configured to adjust a pitch distance,
wherein the pitch management module comprises:
a base structure positioned adjacent to the cultivation area in which the crop is located;
a first movable panel provided on an upper portion of the base structure and being slidable from side to side, wherein the first solar panel is installed on the upper portion;
a second movable panel provided on one side of the first movable panel on the upper portion of the base structure and being slidable from side to side, wherein the second solar panel is installed on the upper portion; and
a third movable panel provided on other side of the first movable panel on the upper portion of the base structure and being slidable from side to side, wherein the third solar panel is installed on the upper portion, and
wherein the pitch distance is adjusted based on at least one of the sliding of the first movable panel, the sliding of the second movable panel, or the sliding of the third movable panel in the solar panel.

16. The agrivoltaic forecasting modeling system of claim 15, wherein the pitch management module further comprises a first gap control module provided on the base structure to be positioned between the first movable panel and the second movable panel,
wherein the first gap control module comprises:
a first movable structure provided between the first movable panel and the second movable panel on the base structure;
a first contact body in contact with the first movable panel through a first connecting body provided on one side of the first movable structure; and
a second contact body in contact with the second movable panel through a second connecting body provided on the other side of the first movable structure;
wherein each of the first contact body and the second contact body is moved forward and backward to limit a degree to which the second movable panel approaches the first movable panel or to reduce the approach speed.

17. The agrivoltaic forecasting modeling system of claim 15, wherein the pitch management module further comprises a second gap control module provided on the base structure to be positioned between the first movable panel and the third movable panel,
wherein the second gap control module comprises:
a first movable structure provided between the first movable panel and the third movable panel on the base structure;
a third contact body in contact with the first movable panel through a third connecting body provided on one side of the second movable structure; and
a fourth contact body in contact with the third movable panel through a fourth connecting body provided on the other side of the second movable structure;
wherein each of the third contact body and the fourth contact body is moved forward and backward to limit a degree to which the third movable panel approaches the first movable panel or to reduce the approach speed.
